(19) United States
(12) Patent Application Publication
(10) Pub. No.: US 2019/0266793 A1
(43) Pub. Date: Aug. 29, 2019

(54) APPARATUS, SYSTEMS, AND METHODS FOR TAGGING BUILDING FEATURES IN A 3D SPACE

(71) Applicant: Lowe's Companies, Inc., Mooresville, NC (US)

(72) Inventors: Mason E. Sheffield, Woodinville, WA (US); Josh Shabtai, Cornelius, NC (US)

(21) Appl. No.: 15/903,501

(22) Filed: Feb. 23, 2018

(51) Int. Cl. G06T 17/05; G06F 17/50; G06T 7/593; G06T 19/00

(52) U.S. Cl. CPC G06T 17/05; G06F 17/5004; G06T 7/593; G06T 2210/04; G06T 2200/24; G06T 2207/10012; G06T 19/006

(57) ABSTRACT

Described herein are systems and methods for using depth and image information for an object within a space to determine physical dimensions for the object and a relative location of the object within the space with respect to a capturing device such as a computer device. In embodiments, the object may be a building feature that is accessible prior to obstructing objects, such as dry wall, obstructing the visibility and accessibility of the building feature. A scene or image information of the space associated with the object may be associated with the depth information and object identification for recall after an obstructing object has been placed over the building feature. The scene may be recalled via an application and may present the location and dimensions for the building feature despite the presence of an obscuring object.

### BACKGROUND

Three-dimensional (3D) models (e.g., 3D representations of building spaces) are often used in a number of architectural and engineering applications. Further, accurate and easily accessible records regarding a number, type, and location of building features (e.g., utility lines and structural components) are not generated or maintained by builders or home owners during a construction project. In some cases, this involves the use of a drafter, who models the space by manually using a computer aided drafting (CAD) application. A number of automated systems are also available that use laser scanners or other sensors for the acquisition of 3D data regarding a physical space. However, these systems often collect point-cloud data which includes an unnecessarily large number of data points, making these systems memory intensive and inefficient with recall operations often including unrequired data.

Systems for generating 3D models of indoor spaces or accurately capturing data that reflects the physical location and dimensions of an object in a space prior to an intervening or obscuring object being placed in the way (e.g., such as dry wall) face a number of additional technical challenges. For example, these systems are often unable to distinguish the space from objects within that space. In some cases, systems are able to identify a location of a line or object within a wall but no records or indication is made for what type of line or structural feature the object within the wall represents. This often results in confusing cloud point data representations for objects within an indoor space that may identify the existence of an object within an indoor space but with poor accuracy and with no identification of the difference from one object to the next within the space. Attempting to accurately capture a location of and physical dimension of an object once an intervening or obscuring object such as a wall has been erected provides further problems as other expensive and inefficient technologies are required to be used, such as X-rays, to identify a location. However, these additional technologies lack the accuracy or ease of identification for lines or objects within an indoor space that can be accurately reproduced within the same space let alone a similar space in another building or location.

Embodiments of the invention address these and other problems, individually and collectively.

### SUMMARY

Techniques described herein are directed to a system, apparatus, and methods for efficiently obtaining and using depth information to generate a 3D representation of an object, such as a building feature (e.g., utility line or structural feature), in a space for later recall that can properly communicate the relative location and physical dimensions of the building feature (e.g., utility line/structural feature) through an obscuring object. In particular, embodiments may involve obtaining both image information as well as depth information for the space. An indication of one or more points is received, via a user interface, with respect to the image information which is then mapped to corresponding points within the space using the depth information. The described system captures or obtains a relative location of the capturing device (e.g., the device capturing the image and depth information) within the space as the one or more points are received via the user interface for use in later recalling the relative physical location for the building features within the space. A user may, via the user interface, select information to associate with building feature such as designating a particular utility line as a water line with a further tagging as a hot water line and leave notes to associate with each building feature within the space. Once the user has provided input to mark or tag the building features within the space, image information of an object(s) within the space or of the space itself may be captured and utilized to properly orient the capturing device for later recall.

One embodiment of the disclosure is directed to a computer-implemented method, comprising: receiving, via a user interface of a computing device, user input that comprises a number of points in a space that correspond to a building feature in the space, determining, by the computing device, a distance from the computing device to the building feature based at least in part on depth information received in relation to the number of points; determining, by the computing device, a relative location of the computing device with respect to the building feature based at least in part on location information obtained by the computing device in response to receiving the user input; obtaining, by the computing device, image information that corresponds to the building feature within the space; generating, by the computing device, a data file that includes a data object for the building feature, the distance to the building feature within the space, the relative location of the computing device with respect to the building feature, and the image information.

Another embodiment of the disclosure is directed to a system comprising: one or more camera devices, a processor, and a memory. The memory includes instructions that, when executed with the processor, cause the system to, at least: obtain, from the one or more camera devices, depth information that corresponds to a plurality of points in a space captured by the one or more camera devices (wherein the plurality of points in the space are associated with input received by the system); calculate, using the depth information, a distance from the one or more camera devices to the plurality of points in the space and physical dimensions for a building feature associated with the plurality of points in the space; obtain, from the one or more camera devices, image information for the space; and generate a data file that includes a 3D representation of the building feature within the space and conforms to the calculated distance and the physical dimensions based at least in part on the image information and the depth information.

Yet another embodiment of the disclosure is directed to an apparatus comprising a camera device configured to capture image information, a depth sensor device configured to capture depth information, a mobile application stored in a computer-readable medium. The mobile application, when executed, may cause the apparatus to receive depth information from the depth sensor for one or more points within a space that correspond to image information captured using the camera device, the one or more points indicated via the mobile application, receive user input, via the mobile application, that indicates a type of building feature to associate with the one or more points within the space, calculate, using the depth information and the user input, a distance and physical dimensions for the building feature within the space that corresponds to the one or more points, and generate a data object that comprises a 3D representation of the building feature within the space that is configured to communicate a first location of the building feature within the space relative to the apparatus and through an obscuring object.

### BRIEF DESCRIPTION OF THE DRAWINGS

Various embodiments in accordance with the present disclosure will be described with reference to the drawings, in which:

FIG. 1 depicts an illustrative overview of an example system in which data points, depth information, and image information may be used to generate a data object that represents a relative location and physical dimensions for a building feature in a space with respect to a capturing device, in accordance with at least some embodiments;

FIG. 2 depicts an illustrative overview of an example system in which the data object may be recalled to accurately present the relative location of the building feature within the space and through an obscuring object such as a wall, via a user interface of a computing device, in accordance with at least some embodiments;

FIG. 3 depicts a system architecture for a system that may be implemented to perform the functionality described in accordance with at least some embodiments;

FIG. 4 depicts a flow chart that illustrates an example process for generating a 3D representation of a building feature in a space and recalling the 3D representation of the building feature in the space that may be implemented in accordance with at least some embodiments;

FIG. 5 depicts a flow chart that illustrates an example process for generating a 3D representation of a building feature in a space and recalling the 3D representation of the building feature in the space that may be implemented in accordance with at least some embodiments;

FIG. 6 depicts an illustrative example of an interaction that may occur using the system described herein in accordance with at least some embodiments;

FIG. 7 depicts a flow diagram which illustrates an example process for generating a 3D representation of one or more data points that correspond to a building feature in a space using depth and image information obtained by a computer device in accordance with at least some embodiments; and

FIG. 8 depicts an illustrative example of a user device capable of performing at least a portion of the functionality described herein.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

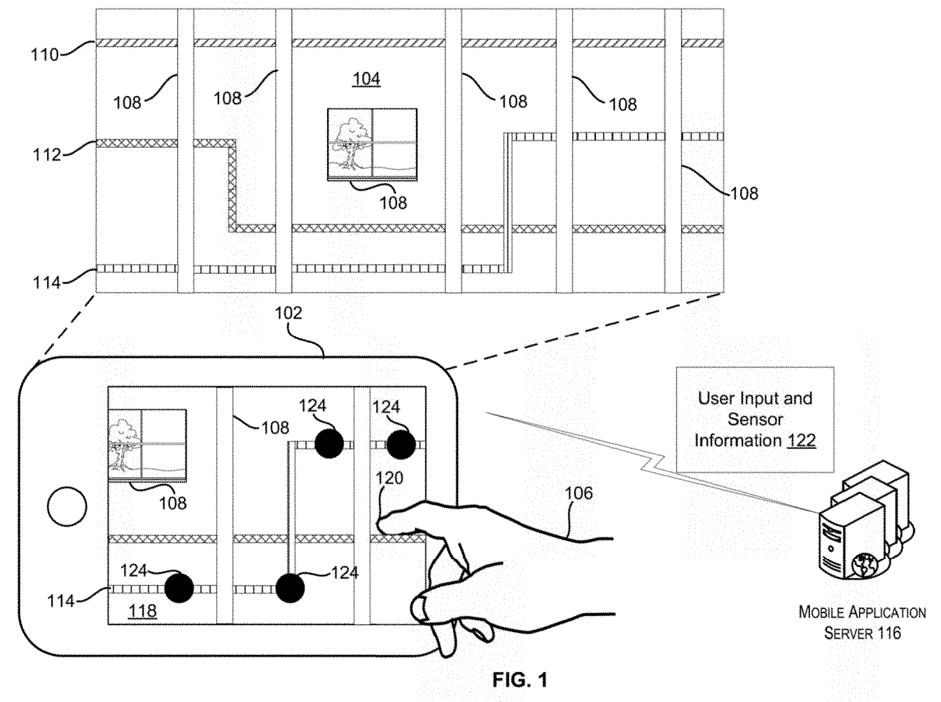

FIG. 1 depicts an illustrative overview of an example system in which data points, depth information, and image information may be used to generate a data object that represents a relative location and physical dimensions for a building feature (e.g., an HVAC duct, electrical wiring, communication line, gas line, plumbing component or pipe, wall stud or other structural support, or the like) in a space with respect to a capturing device, in accordance with at least some embodiments. In FIG. 1, a user device 102 is depicted as being operated within a space 104 by a user 106. The space 104 includes one or more building features (e.g., structural features 108 as well as one or more different types of utility lines 110-114). In embodiments, the user device 102 may be in communication with mobile application server 116.

For clarity, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the internet), using any suitable communication protocol.

In some embodiments, the user device 102 may include a mobile application that, when executed, causes the user device 102 to capture input sensor data from a number of input sensors in relation to the space 104. By way of example, the user device 102 may capture image information, depth information, calibration information, and geographic location information (e.g., GPS coordinates) with respect to the space 104 and/or the user device 102. The user device 102 may be configured to display at least a portion of the obtained input information to a user. For example, a display 118 on the user device 102 may be used to present image information captured by a camera installed on the user device 102. The image information may be obtained by the user device 102 in parallel to, and to correspond with, depth sensor output (e.g., a depth map or depth information) obtained using a depth sensor installed on the user device 102 and in response to user provided input 120.

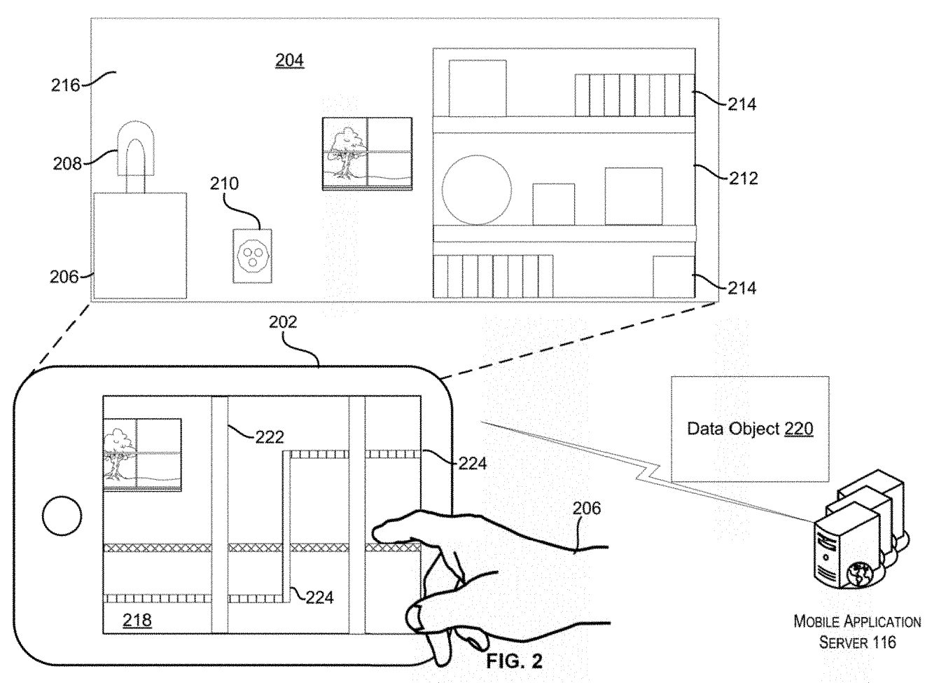

In embodiments, the mobile application server 116 may be configured to receive the input sensor output from the user device 102 and generate a 3D representation of the objects (e.g., building features such as the utility lines 110-114 and structural features 108) within the space 104. For example, the user device 102 may obtain depth information and location information from the user device 102 in response to or parallel with the user provided input 120. The mobile application server 116 may also receive an indication of at least one point selected by the user (e.g., user provided input 120) within the depth information and corresponding to the building features (108 and 110-114) within the space 104. The mobile application server 116 may receive the obtained depth information and location information 122. In embodiments, the mobile application server 116 may determine the depth or distance from the user device 102 to the building features 108 and 110-114 within the space 104 based on the obtained depth information, location information 122, and the user provided input (e.g., 120) that tags or identifies the building features 108 and 110-114 in the display 118. In accordance with at least one embodiment, the mobile application server 116 may be configured to capture a scene or origination point for use in recalling and calibrating the 3D representation of the building features and accurately communicating or presenting the distance and dimensions of the building features within the space 104 and through an obscuring object such as a wall (e.g., dry-wall or sheet rock, paneling, or other features that hide from view a building's structural supports and utility lines), as described with reference to FIG. 2. In some embodiments, the mobile application server 116 may use the location information to identify the originating point for the user device 102 to recall the scene or space 104 and building features 108 and 110-114 for display to the user.

In accordance with at least some embodiments, a user of, and/or an account associated with, the user device 102 may be identified. The account may be one that is maintained on behalf of the user by the mobile application server 116. In some embodiments, the user/account may be identified based on a phone number or serial number associated with the user device 102. In some embodiments, the user may be asked to sign into an account upon execution of a mobile application on the user device 102, such that any actions performed using the mobile application may be automatically associated with the logged account. The generated 3D representation may be stored in a number of ways. For example, in some embodiments, the 3D representation may be stored as a wireframe representation of the building features 108 and 110-114 of the space 104. In some embodiments, the 3D representation may be stored as a series of layers that can be revealed or hidden with respect to the space based on user input.

By way of illustrating interactions between various components depicted in FIG. 1, consider a scenario in which a user enters a room (i.e., an example space 104) having a number of building features 108 and 110-114 within the space 104 prior to an obscuring object such as a wall being placed over building features 108 and 110-114. The user may wish to generate a 3D representation of the building features 108 and 110-114 within the space 104 that can accurately communicate the distance, depth, and dimensions of the building features via the user device 102 (e.g., a tablet or mobile phone) and display 118. The mobile application of user device 102 may cause the user device 102 to activate both a camera device and a depth sensor installed upon the user device in order to capture input related to the space 104. The image information captured by the camera device may be displayed upon the display 118 of the user device 102 and correspond to the user-provided input. In this illustrative example, the user 106 may select a number of points 124 within the image information displayed on the user device 102 which corresponds to actual points within the space 104 and utility line 114. The user device 102 may obtain depth information for the number of points 124. In embodiments, depth information for the area immediately surrounding points 124 may also be captured. In embodiments, the user device 102 may utilize the depth information, user input, and image information to determine a distance, depth, and dimensions for a corresponding building feature (e.g., utility line 114) within the space 104. In some embodiments, the depth information, user input, and image information may be transmitted to the mobile application server 116 to determine a distance, depth, and dimensions for a corresponding building feature (e.g., utility line 114) within the space 104. The mobile application server 116 may generate a 3D representation of the building feature (e.g., utility line 114) within the space 104 that can be later recalled via the user device 102 to identify or determine an accurate location, distance, and dimension for the building feature within the space 104 after an obscuring object such as a wall obstructs the user's ability to see the actual building feature and identify such information.

It should be noted that in the illustrative example above, the user device 102 may have installed a motion tracking camera, which tracks the relative position of the image information with respect to the user device 102. Accordingly, the user may be able to walk around the space 104 and reposition the user device 102 while still accurately capturing depth information, image information, and user input.

FIG. 2 depicts an illustrative overview of an example system in which the data object may be recalled to accurately present the relative location of the building feature within the space and through an obscuring object such as a wall, via a user interface of a computing device, in accordance with at least some embodiments. In FIG. 2, a user device 202 is depicted as being operated within a space 204 by a user 206. The space 204 includes one or more obscuring objects from the same space 104 of FIG. 1. For example, the space 204 includes a nightstand 206, a lamp 208, an electrical outlet 210, a bookcase 212 holding other objects 214, as well as a wall 216. In embodiments, user device 202 may be in communication with mobile application server 116.

For clarity, a certain number of components are shown in FIG. 2. It is understood, however, that embodiments of the invention may include more than one of each component. In addition, some embodiments of the invention may include fewer than or greater than all of the components shown in FIG. 2. In addition, the components in FIG. 2 may communicate via any suitable communication medium (including the internet), using any suitable communication protocol.

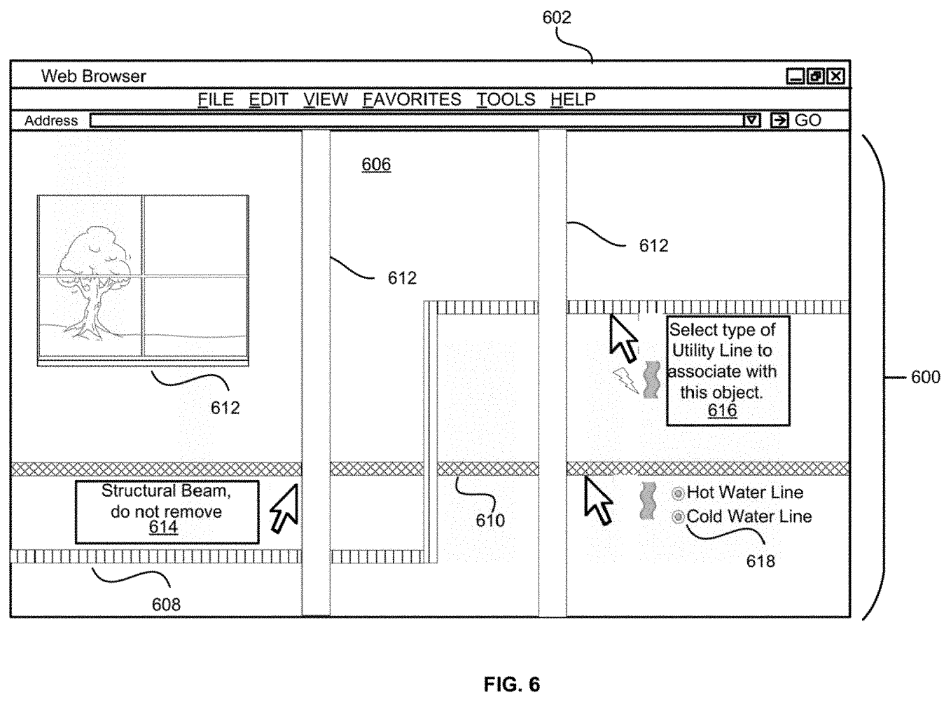

In FIG. 2, the user 206 may interact with display 218 of user device 202 to request the data object or 3D representation of the space 104 that is associated with the space 204 from mobile application server 116. In response to the request, the mobile application server 116 may transmit the data object 220 that includes scene data and layer data for the building features 108 and 110-114 for the space 104/204. As described herein, once the user 206 has calibrated or returned the user device 202 to the originating point (e.g., the location where the user device that captured the data about the space 104 was initiated in FIG. 1), the user device 202 may display, via display 218 using the data object 220, the 3D representations 222 and 224 for the building features 108 and 114 from the space 104 of FIG. 1 as if the user could see through the wall 216. The display 218 may accurately and efficiently communicate to the user 206 the depth, distance, and dimensions of building features 108 and 114 (displayed as 3D representations 222 and 224) as if the user could see through the intervening object (e.g., wall 216) and other obscuring objects 206-214. The user may interact with the display to view other information associated with the building features 108 and 114 (displayed as 3D representations 222 and 224) such as notes or indications of types of utility lines as described in FIG. 6. Further, the user is enabled to work on the space 204 and obscured building features 108 and 110-114 without having to remove or otherwise damage wall 216 to determine the distance from the user device 202 to the building features 108 and 110-114 or the dimensions and locations of the building features 108 and 110-114.

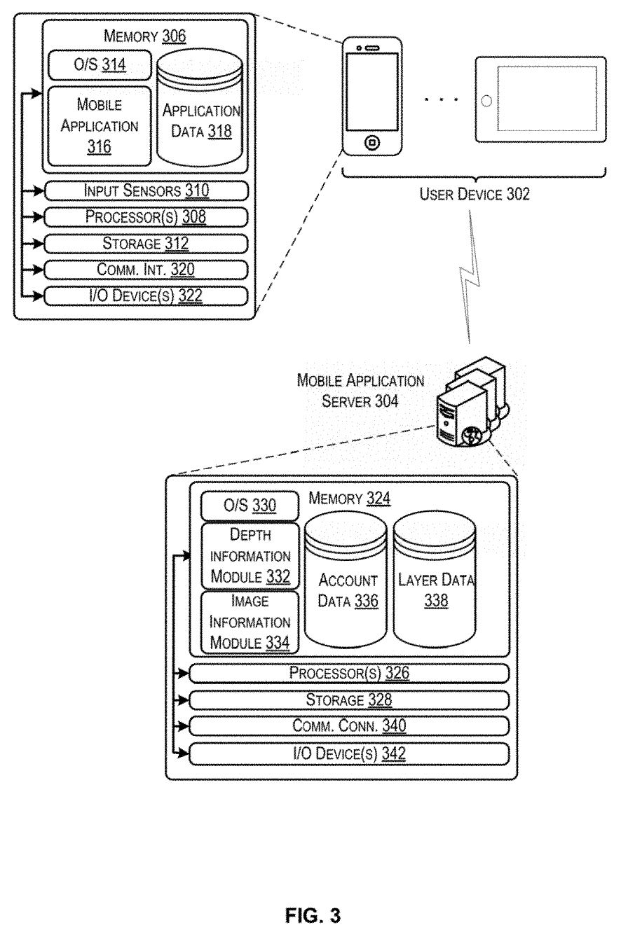

FIG. 3 depicts a system architecture for a system that may be implemented to perform the functionality described in accordance with at least some embodiments. In FIG. 3, a user device 302 may be in communication with a number of other components, including at least a mobile application server 304. The mobile application server 304 may perform at least a portion of the processing functions required by a mobile application installed upon the user device.

A user device 302 may be any suitable electronic device that is capable of providing at least a portion of the capabilities described herein. In particular, the user device 302 may be any electronic device capable of identifying an object and its location within a space. In some embodiments, a user device may be capable of establishing a communication session with another electronic device (e.g., mobile application server 304) or a third-party computer (e.g., another user device and/or a third party computer (not pictured)) and transmitting/receiving data from that electronic device. A user device 302 may include the ability to download and/or execute mobile applications. User devices 302 may include mobile communication devices as well as personal computers and thin-client devices. In some embodiments, a user device 302 may comprise any portable electronic device that has a primary function related to communication. For example, a user device 302 may be a smart phone, a personal data assistant (PDA), or any other suitable handheld device. The user device 302 can be implemented as a self-contained unit with various components (e.g., input sensors, one or more processors, memory, etc.) integrated into the user device 302. Reference in this disclosure to an “output” of a component or an “output” of a sensor does not necessarily imply that the output is transmitted outside of the user device 302. Outputs of various components might remain inside a self-contained unit that defines a user device 302.

In one illustrative configuration, the user device 302 may include at least one memory 306 and one or more processing units (or processor(s)) 308. The processor(s) 308 may be implemented as appropriate in hardware, computer-executable instructions, firmware or combinations thereof. Computer-executable instruction or firmware implementations of the processor(s) 308 may include computer-executable or machine executable instructions written in any suitable programming language to perform the various functions described. The user device 302 may also include one or more input sensors 310 for receiving or capturing user and/or environmental input. There may be a variety of input sensors 310 capable of detecting user or environmental input, such as an accelerometer, a camera device, a depth sensor, a microphone, a global positioning system (e.g., GPS) receiver, etc. The one or more input sensors 310 may include at least a range camera device (e.g., a depth sensor) capable of generating a range image, as well as a camera device configured to capture image information.

For the purposes of this disclosure, a depth sensor (e.g., a range camera) may be any device configured to identify a distance or range of an object or objects from the depth sensor. In some embodiments, the depth sensor may generate a depth image (or range map), in which pixel values correspond to the detected distance for that pixel. The pixel values can be obtained directly in physical units (e.g., meters). In at least some embodiments of the disclosure, the 3D imaging system may employ a range camera that operates using structured light. In a depth sensor that operates using structured light, a projector projects light onto an object or objects in a structured pattern. The light may be of a range that is outside of the visible range (e.g., infrared or ultraviolet). The depth sensor may be equipped with one or more camera devices configured to obtain an image of the object with the reflected pattern. Distance information may then be generated based on distortions in the detected pattern. It should be noted that although this disclosure focuses on the use of a depth sensor using structured light, any suitable type of depth sensor, including those that operate using stereo triangulation via one or more stereoscopic cameras, sheet of light triangulation, time-of-flight, interferometry, coded aperture, or any other suitable technique for range detection, would be useable by the described system.

The memory 306 may store program instructions that are loadable and executable on the processor(s) 308, as well as data generated during the execution of these programs. Depending on the configuration and type of user device 302, the memory 306 may be volatile (such as random access memory (RAM)) and/or non-volatile (such as read-only memory (ROM), flash memory, etc.). The user device 302 may also include additional storage 312, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 306 may include multiple different types of memory, such as static random access memory (SRAM), dynamic random access memory (DRAM) or ROM. Turning to the contents of the memory 306 in more detail, the memory 306 may include an operating system 314 and one or more application programs or services for implementing the features disclosed herein including at least a mobile application 316. The memory 306 may also include application data 318, which provides information to be generated by and/or consumed by the mobile application 316. In some embodiments, the application data 318 may be stored in a database.

For the purposes of this disclosure, a mobile application 316 may be any set of computer executable instructions installed upon, and executed from, a user device 302. Mobile applications may be installed on a user device by a manufacturer of the user device or by another entity. In some embodiments, the mobile application 316 may cause a user device 302 to establish a communication session with a mobile application server 304 that provides backend support for the mobile application 316. A mobile application server 304 may maintain account information associated with a particular user device and/or user. In some embodiments, a user may be required to log into a mobile application 316 in order to access functionality provided by the mobile application 316.

In accordance with at least some embodiments, the mobile application 316 may be configured to, in conjunction with the processors 308 and input sensors 310, capture depth information and image information that corresponds to user input for identifying one or more building features, such as utility lines, within a space. The mobile application 316 may utilize the user input, the depth information, and the image information to determine a distance from the user device 302 to the intended point within a space which can be used by the mobile application 316 to generate a data object that includes a 3D representation of the building feature within the space that accurately communicates its location and depth relative to the user device 302 within the space.

The user device 302 may also contain communications interface(s) 320 that enable the user device 302 to communicate with any other suitable electronic devices. In some embodiments, the communication interface 320 may enable the user device 302 to communicate with other electronic devices on a network (e.g., on a private network). The user device 302 may also include input/output (I/O) device(s) and/or ports 322, such as for enabling connection with a keyboard, a mouse, a pen, a voice input device, a touch input device, a display, speakers, a printer, etc.

In some embodiments, the user device 302 may communicate with the mobile application server 304 via a communication network. The communication network may include any one or a combination of many different types of networks, such as cable networks, the Internet, wireless networks, cellular networks, and other private and/or public networks. In addition, the communication network may comprise multiple different networks. For example, the user device 302 may utilize a wireless local area network (WLAN) to communicate with a wireless router, which may then route the communication over a public network (e.g., the Internet) to the mobile application server 304.

The mobile application server 304 may be any computing device or plurality of computing devices configured to perform one or more calculations on behalf of the mobile application 316 on the user device 302. In some embodiments, the mobile application 316 may be in periodic communication with the mobile application server 304. For example, the mobile application 316 may receive updates, push notifications, or other instructions from the mobile application server 304. In some embodiments, the mobile application 316 and mobile application server 304 may utilize a proprietary encryption and/or decryption scheme to secure communications between the two. In some embodiments, the mobile application server 304 may be executed by one or more virtual machines implemented in a hosted computing environment. The hosted computing environment may include one or more rapidly provisioned and released computing resources, which computing resources may include computing, networking, and/or storage devices. A hosted computing environment may also be referred to as a cloud-computing environment.

In one illustrative configuration, the mobile application server 304 may include at least one memory 324 and one or more processing units (or processor(s)) 326. The processor(s) 326 may be implemented as appropriate in hardware, computer-executable instructions, firmware or combinations thereof. Computer-executable instruction or firmware implementations of the processor(s) 326 may include computer-executable or machine executable instructions written in any suitable programming language to perform the various functions described.

The memory 324 may store program instructions that are loadable and executable on the processor(s) 326, as well as data generated during the execution of these programs. Depending on the configuration and type of mobile application server 304, the memory 324 may be volatile (such as random access memory (RAM)) and/or non-volatile (such as read-only memory (ROM), flash memory, etc.). The mobile application server 304 may also include additional storage 328, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 324 may include multiple different types of memory, such as static random access memory (SRAM), dynamic random access memory (DRAM) or ROM. Turning to the contents of the memory 324 in more detail, the memory 324 may include an operating system 330 and one or more application programs or services for implementing the features disclosed herein including at least a depth information module 332 and an image information module 334. The memory 326 may also include an account database 336 and a layer database 338.

The memory 324 and the additional storage 328, both removable and non-removable, are examples of computer-readable storage media. For example, computer-readable storage media may include volatile or non-volatile, removable or non-removable media implemented in any method or technology for storage of information such as computer-readable instructions, data structures, program modules or other data. As used herein, the term “modules” may refer to programming modules executed by computing systems (e.g., processors) that are installed on and/or executed from the mobile application server 304. The mobile application server 304 may also contain communications connection(s) 340 that allow the mobile application server 304 to communicate with a stored database, another computing device or server, user terminals, and/or other components of the described system. The mobile application server 304 may also include input/output (I/O) device(s) and/or ports 342, such as for enabling connection with a keyboard, a mouse, a pen, a voice input device, a touch input device, a display, speakers, a printer, etc.

Turning to the contents of the memory 306 in more detail, the memory 306 may include a depth information module 332, an image information module 334, a database containing account data 336, and/or a database containing layer data 338.

In some embodiments, the depth information module 332 may be configured to, in conjunction with the processors 326, receive depth information and potentially location information from the user device 302 and calculate a distance from the capturing device (e.g., user device 302) to a building feature within a space that corresponds to one or more points within the space that have been identified by the user utilizing the user device 302 and mobile application 316. In some embodiments, the depth information module 332 may receive calibration information that can be utilized to determine the physical dimensions for the building feature within the space that corresponds to the one or more points within the space that have been identified by the user. In embodiments, the depth information module 332 may be configured to interpret images captured by the input sensors 310 of the space and identify a reference marker provided by a user and/or generated by the user device 302.

In some embodiments, the image information module 334 may be configured to, in conjunction with the processors 326, generate a data object that corresponds to a 3D model or representation of a building feature associated with the one or more points in a space as indicated by a user. The 3D model or representation may be for a utility line, a structural feature, or other object (an HVAC duct, electrical wiring, communication line, gas line, plumbing component or pipe, wall stud or other structural support, or the like) within the space. In embodiments, the image information module 334 may be configured to associate one or more layers with the data object based on the number and/or type of building features captured or indicated by the user providing the user input via user device 302. For example, if the user identifies two different types of utility lines, a water line and an electrical line, the image information module 334 may generate different layer objects for each type of utility line and associate the layers with the 3D representation or data object that is subsequently generated. In embodiments, the image information module 334 may be configured to transmit a portion of the data object which may correspond to only one of a plurality of layers that are associated with the data object for a given space if a user selects only that layer. In some embodiments, the image information module 334 may be configured to transmit sequentially portions of the data object which may correspond to only one of a plurality of layers that are associated with the data object for a given space if a user elects to view the different building features sequentially via a sequential layering of the building features into the display 218 (i.e., elects sequential adding of layers to the display 218). For example, the display 218 might show a 3D representation 224 of the utility lines first and in the next instance might show a 3D representation of the wall studs 222 superimposed over the utility lines (or alone without the utility lines).

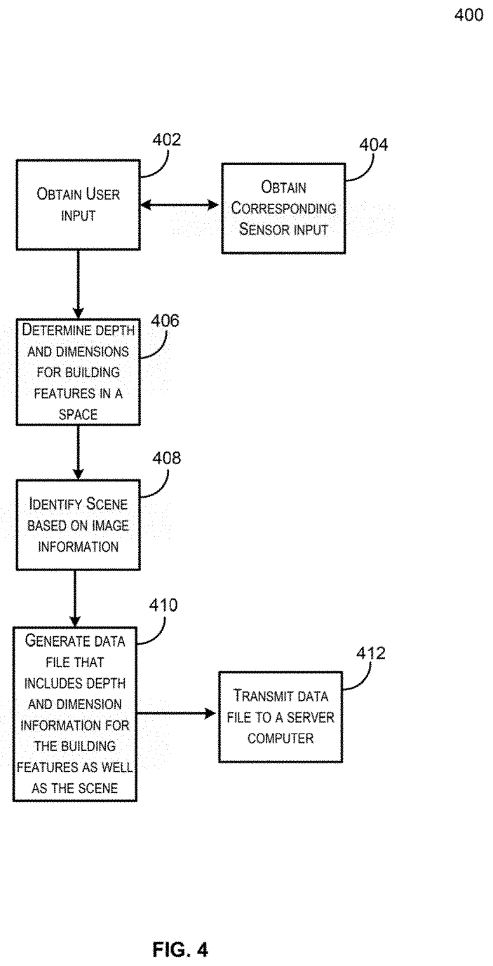

FIG. 4 depicts a flow chart that illustrates an example process for generating a 3D representation of a building feature in a space and recalling the 3D representation of the building feature in the space that may be implemented in accordance with at least some embodiments. Some or all of the process 400 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. Process 400 may be performed by an example user device 302, a mobile application server 304, and/or various other components, examples of which are depicted with respect to FIG. 3.

The process 400 may begin at 402, when the system receives user input obtained from a user device. In embodiments, the user input may correspond to one or more points within a space and be received via an indication on a display of a user device (e.g., a user's touch on a touchscreen device or a cursor selection of a point) with respect to image information obtained by a camera sensor of the user device. The user device may display the image information on its display.

The process 400 may include, at 404, obtaining corresponding sensor input simultaneously as the user input is obtained at 402. The system may receive sensor input as well as position data, obtained from the user device. As described elsewhere, the sensor input may include image information as well as depth sensor output. In some embodiments, the sensor input may be received as a stream of data. For example, the input sensor data may be received as a video stream. In some embodiments, at least a portion of the process 400 may be performed at a user device. For example, a user device may receive in parallel, via a depth sensor and a camera, both depth information and image information for a scene. In this example, the depth information and the image information may be associated, in that pixels within the image information correspond to pixels within the depth information.

At 406, the process 400 may include determining depth and dimensions for building features in a space. For example, based on the user's input at 402, a point within the depth information may be identified that corresponds to the point indicated with respect to the image information. For example, a pixel or pixels that are located in a position within the depth information that corresponds to the position of the indicated point within the image information may be determined. These pixels within the depth information may be assigned a value that corresponds to a depth or distance of the point from the user device. Calibration information obtained by the user device may be used to determine the dimensions of objects as described herein.

The process 400 may include, at 408, identifying a scene based on image information or location information. In embodiments, a common point of reference (e.g., an origin point) may be identified such that any subsequent recalls for the data object generated by the process 400 may be properly calibrated to accurately display the relative location, distance, and dimensions of the building features within the space that are identified by the user input. In some embodiments, identifying the scene may include capturing a set position in the space or an particular object and position within the space at which the user device was located at the time that the process 400 was initiated.

The process 400 may include generating a data file or data object that includes depth and dimension information for the building features that correspond to the user input as well as the scene. In embodiments, the mobile application 316 and/or the mobile application server 304 may generate layers that represent the different types of building features identified within the space and that correspond to the user input as well as the image information that corresponds to the scene. As described herein with reference to FIG. 6, the data file or data object may include metadata or other similar information that further enhances or modifies the user input provided via the user interface. For example, the user may use the user interface of a user device to add notes, select a type of building feature or utility line, or provide other metadata. In embodiments, the process 400 may conclude by transmitting the data file to a server computer at 412. For example, the mobile application 316 may transmit periodically or as a stream the depth information, user input, and image information to the mobile application server 304 for generating the data file. In some embodiments, the mobile application 316 may generate the data file and transmit it to the mobile application server 304 for associating the file with a particular user profile according to the account data 336.

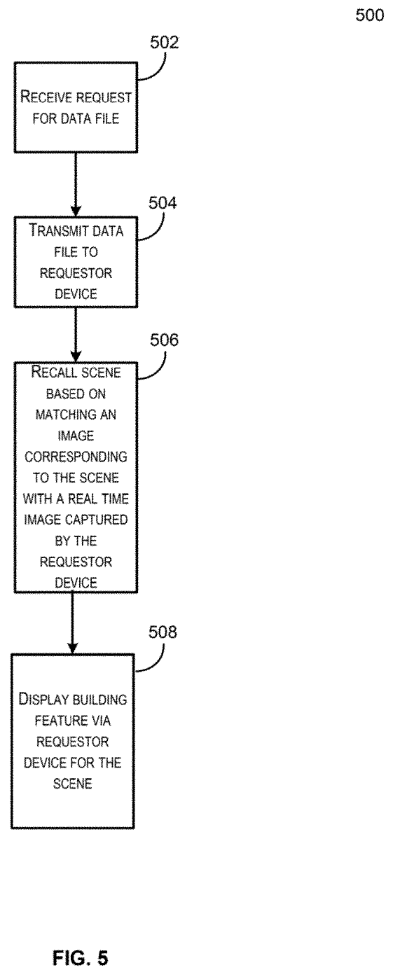

FIG. 5 depicts a flow chart that illustrates an example process for generating a 3D representation of a building feature in a space and recalling the 3D representation of the building feature in the space that may be implemented in accordance with at least some embodiments. Some or all of the process 500 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. Process 500 may be performed by an example user device 302, a mobile application server 304, and/or various other components, examples of which are depicted with respect to FIG. 3.

The process 500 may begin at 502 by receiving a request for a data file. In embodiments, the same user device 302 that captured the depth information and image information when generating the data file may later request the data file for displaying the identified building features (e.g., utility lines and/or structural features) to the user via a user interface. In some embodiments, the request for the data file may come from a third party with permission being granted by the user to share access to the data file. In some embodiments, the user who generated the file may wish to only share certain layers of the data file (e.g., certain utility lines or structural features) to a third party which may be included in the request. The process 500 may include transmitting the data file to a requestor device at 504. In embodiments, the mobile application server 304 may transmit the data file to the requestor device using a network such as a private network (i.e., the Internet).

The process 500 may include recalling the scene at the requestor device based on matching an image corresponding to the scene with a real time image captured by the requestor device at 506. As described herein, the requestor device may have a user interface which accesses the received data file and displays an overlay or AR representation of the scene over the real time image information captured by a camera device or sensor of the requestor device. The requestor device may be configured to identify the origin point, as described above, that can be used to calibrate the layers, data objects, and intended objects such as building features (e.g., utility lines and structural features) with the position of the requestor device. The process 500 may conclude at 508 by displaying the building feature via the user interface of the requestor device for the scene in response to matching the overlay of the scene with the real time image information. Once the scene is displayed, a user may interact with the user interface to be presented with the various building features within the space which accurately represent a distance or depth from the requestor device to the building feature as well as physical dimensions for the building feature as if the user could see through an obscuring object such as a wall that is present during such interaction but was not previously present in the space when the building feature data was originally captured.

FIG. 6 depicts an illustrative example of an interaction that may occur using the system described herein in accordance with at least some embodiments. FIG. 6 includes a user interface 600 that is displayed or presented via a web browser 602. The web browser 602 may be implemented by memory and processors of a user device, such as user device 302 and correspond to a mobile application such as mobile application 316. The user interface 600 of FIG. 6 depicts one or more interactions that a user may have with the user interface 600 of the embodiments described herein to provide further data, notes, or metadata with which to associate with one or more objects within a space. The user interface 600 depicted in FIG. 6 represents a given wall 606 of a home or facility prior to placing dry wall or some other obscuring object on top of or between the view of a user and one or more building features (e.g., utility lines 608-610 and structural features (612).

In embodiments, a user may interact with user interface 600 to provide further input or information with which to associate and further enhance the one or more data points that are being associated with a building feature, such as utility line 608. For example, in FIG. 6 at 614, a user may provide notes that will be associated with a building feature captured by the depth sensors or camera sensors of a user device (e.g., “Structural Beam, do not remove”). In embodiments, a user may identify a type of utility line with which to associate to a building feature, such as at 616 where a user may indicate whether the one or more data points that are associated with a utility line may be specifically for an electric line or a water line. Further, the user may provide metadata or interact with one or more flags, radio buttons, or other types of identifiers for data that are specific to a type of data object such as at 618. For example, once a user has selected that a particular utility line is for a water line, the user may further specify that the water line is a hot or cold water line at 618. As described herein, when a user recalls the scene for this space (606), using the user interface 600 or a similar user interface displayed via a user device 302, the utility lines 608 and 610 as well as the structural features 612 may be presented as an overlay that enables the user to identify the relative location and dimensions for those building features 608, 610, and 612 and see them as if the user could see through an obscuring object such as a wall. Further, the user may be able to interact with the layers or data objects of the user interface 600 to be presented with the additional information such as the notes 614, the type of data object 616, and any associated metadata 618. It should be recognized that one of skill in the art would be aware of a number of techniques for other data that may be identified by a user and associated with the building features 608, 610, 612 and space 606 using the depth and image information of a user device implementing one or more sensors.

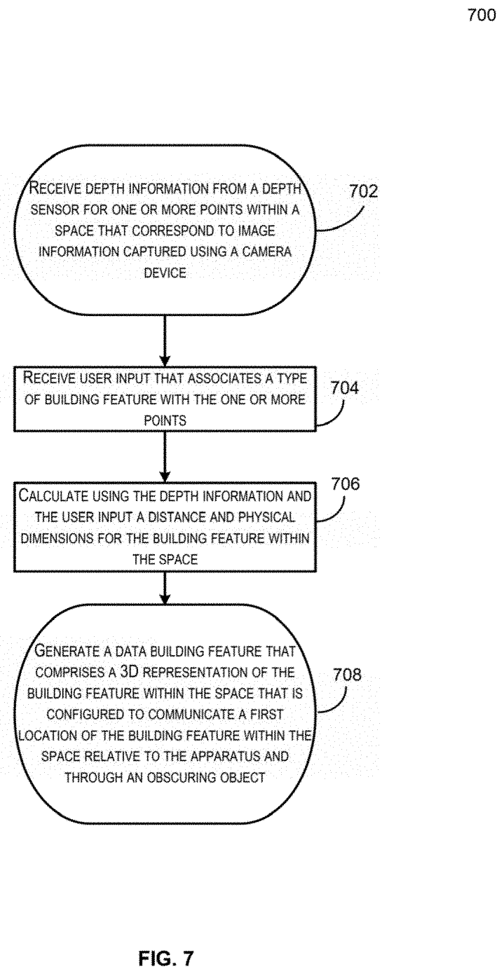

FIG. 7 depicts a flow diagram which illustrates an example process for generating a 3D representation of one or more data points that correspond to a building feature in a space using depth and image information obtained by a computer device in accordance with at least some embodiments. Process 700 may be performed using some combination of a user device 302 and/or a mobile application server 304, examples of which are depicted with respect to FIG. 3.

Process 700 may begin at 702 when depth information from a depth sensor for one or more points within a space that correspond to image information captured using a camera device is received. In embodiments, the depth information and image information may be referred to as sensor output which corresponds to the output from the data captured by depth sensors and/or cameras of a device. The sensor output may be obtained using multiple sensors devices installed on a single user device. In some embodiments, the sensor output may be received as a single still image.

At 704, the process may involve receiving user input that associates a type of building feature with one or more points within the space. In embodiments, the process may involve receiving indications of points within the obtained sensor output. In some embodiments, the indication is received via a touch on a display of the user device at a point within image information. Based on this indication, a point within the depth information may be identified that corresponds to the point indicated with respect to the image information. For example, a pixel or pixels that are located in a position within the depth information that corresponds to the position of the indicated point within the image information may be determined. In embodiments, a plurality of types of building features may be identified based on the received user input. Each or some types of building features of the plurality of types of building features may be stored as a separate layer within a data object.

At 706, the process may involve calculating a distance and physical dimensions for the building feature within the space using the depth information and the user input. In embodiments, a mobile application of the capturing device (e.g., user device) may be configured to use the depth information captured by associated depth sensors to determine the distance from the capturing device to each point of the one or more points in the space. Calibration information captured by the device can also be used by the mobile application to determine physical dimensions for the object. For example, the device may generate a light of a certain frequency that is configured to be captured by a camera device of the user device to enable the mobile application to determine a size of a corresponding object captured by the camera device by using the size of the light as a reference marker at a known distance from the use device. The light may be configured to have certain physical dimensions (e.g., a size) based on its distance from the light emitting source to the object it is hitting. Based on the size of the light as captured by the user device within a certain distance, the mobile application may be configured to determine a size of an object that corresponds to the one or more points. In some embodiments, 3D perspective geometry may be utilized to determine the physical dimensions for the objects that correspond to the data points indicated by a user within the space. It should be recognized that one skilled in the art would be aware of a number of techniques for determining the size and/or physical dimensions of an object using one or more sensors.

At 708, the process may involve generating a data object that comprises a 3D representation of the building feature within the space that is configured to communicate a first location of the building feature within the space relative to the apparatus and through an obscuring object. For example, a user may interact with the mobile application of a user device to recall a scene or calibrate the user device to a particular location within the space. For example, a user interface may present an augmented reality (AR) of a scene that includes an real-world outline image for one or more objects or locations within the space where the one or more points corresponding to the object were captured. Once the device has been appropriately calibrated within the space by positioning the AR scene overlay over the corresponding real world equivalent, the user interface may present one or more layers or 3D representations of building features (e.g., utility lines and/or structural features) via the user interface. The real-world camera feed obtained by the cameras of the user device may be overlaid with the layers, data objects, and/or 3D representations of the previously tagged or indicated building features, such as utility lines or structural features (e.g., one or more points within the space). The 3D representations of the building features (e.g., utility lines or structural features) can be used to accurately communicate to the user the relative location, depth, and physical dimensions for the building features within the space as if the user could see through an intervening or obscuring object such as a wall.

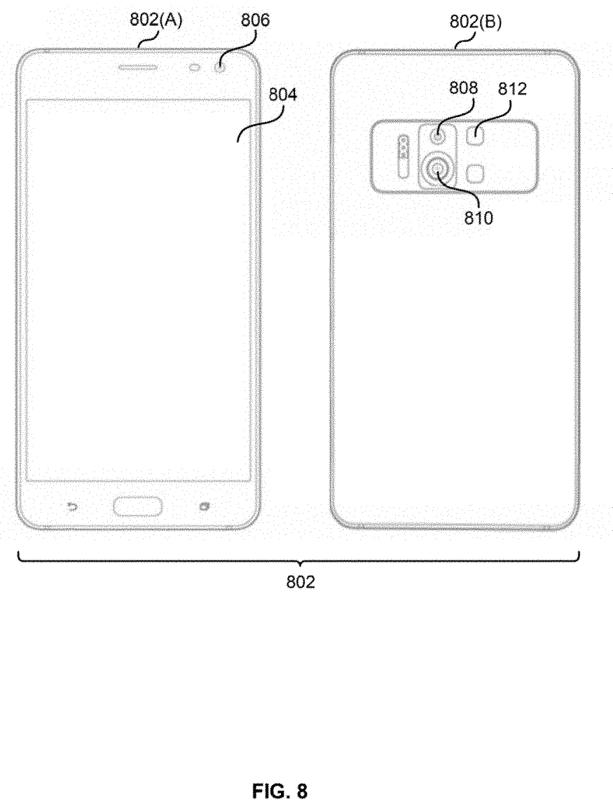

FIG. 8 depicts an illustrative example of a user device capable of performing at least a portion of the functionality described herein. In FIG. 8, a front 802(A) and back 802(B) are depicted for a user device 802. The depicted user device 802, as may be used in some particular embodiments of the system described herein, may be a ZENFONE AR (ZS571KL) smartphone device manufactured by ASUS corporation or a PHAB 2 PRO smartphone device manufactured by LENOVO corporation.

As depicted in FIG. 8, the user device 802 may include a display screen 804 capable of displaying image information to a user of the user device 802. Additionally, the user device 802 may include a number of camera devices. For example, the user device 802 may include a front-facing camera 806. Additionally, the user device 802 may include multiple rear-facing cameras, each of which serves different purposes. For example, the rear-facing cameras of the user device 802 may include both a high-resolution camera device 808 for capturing detailed images, a motion tracking camera 810 for tracking the user device's location as it moves through space while capturing image information, and a depth sensor camera 812 for capturing depth information associated with captured image information.

Additionally, the user device 802 may include software that, in conjunction with a number of processors of the user device 802, provides at least a portion of the functionality described herein. For example, the software application TANGO, which is developed by GOOGLE corporation, enables motion tracking, area learning, and depth perception functionality on the depicted user device 802. A mobile application, as described herein, which is installed upon the user device 802 may use one or more of these functionalities by performing an API or method call in accordance with TANGO specifications. Accordingly, it should be noted that the system described herein is fully enabled by the combination of hardware and software depicted.

Embodiments of the invention provide for a number of technical advantages over conventional systems. Conventional systems which generate 3D representations of a space often use devices (e.g., LIDAR) that can capture an entire space as well as all of the items within that space. This results in the collection of a large amount of point cloud data, some of which is not actually part of the space. Further, algorithms utilized to parse the data may utilize point cloud data that is inappropriate or inaccurate for the target object desired to be captured by the device. Unlike conventional systems that indiscriminately capture point cloud data of a space, systems and methods described herein provide for guided data gathering techniques by using user input to obtain point data for particular objects within in a space such as a building feature. As the systems obtain or capture data regarding objects based on user input the amount of data required to generate a 3D representation of the same space is minimized. Further, the systems described herein are able to generate a 3D representation of the building features (e.g., utility lines/structural features) that can be used to accurately identify the location and physical dimensions of the building features (e.g., utility lines/structural features) despite the presence of an obscuring object (i.e., a wall) between the user device presenting the 3D representation and the real-world physical building feature. The system is able to generate the 3D representation based on the data object generated using the depth and image information and communicate the relative location of the corresponding building feature (e.g., utility line or structural feature) regardless of any amount of clutter or other objects in the space.

Furthermore, because the system described herein uses a user-guided approach to identify building features such as utility lines and structural features of a space, the system is able to account for objects with unconventional or customized shapes, sizes, and directionality within the space. For example, conventional systems are often unable to distinguish atypical or customized structural features (e.g., beams, protrusions, depression, etc.) as well as other objects from the target object. The current system is able to account for these atypical or customized structural features using guidance provided by a user. For example, in the system described herein, a user may indicate which particular points within a space to gather depth information about which will then be reflected in a data object used to generate the 3D representation of a corresponding building feature. Conventional systems often gather data in a haphazard fashion that captures unneeded data that can result in incorrect shapes, sizes, and directionality of 3D representations of corresponding objects in the real world absent the user provided guidance. This can result in a loss of accuracy regarding the physical dimensions and relative location of the building feature which is important when attempting to perform work on building features located on an opposite side of an obscuring object such as a wall and relying on the information associated with the 3D representation of the building features.

The system and methods described herein also can be configured to allow transfer of an account or the information gathered about a building (or in connection with a particular account) to another user of the system and/or methods (e.g., a renter of the building, a new owner of the building, a plumber, technician, electrician, contractor, or other person or entity who will diagnose and repair problems with the building or will make improvements to the building). This provides a convenient way of communicating important information about hidden features of a building to a person who might otherwise damage the building (e.g., by cutting through dry-wall) to determine where those features of the building are located. In some embodiments, the system and method can be configured to allow temporary access to such other users instead of transferring the account or information permanently. The system, for example, can be configured to authorize access and invite such other users (e.g., by text message, e-mail or otherwise) to establish a LOG-IN ID and password. The system can be configured to de-activate the LOG-ID and password at a pre-determined time (automatically or otherwise) or at a later designated time (e.g., when work on the building is expected to be completed or when it is actually completed by the other user).

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method, comprising:
receiving, via a user interface of a computing device, user input that comprises a number of points in a space that correspond to a building feature in the space;
determining, by the computing device, a distance from the computing device to the building feature based at least in part on depth information received from at least one sensor of the computing device, in relation to the number of points;
determining, by the computing device, a relative location of the computing device with respect to the building feature based at least in part on location information obtained by the computing device in response to receiving the user input;
capturing, by the computing device, at least one image of the building feature and generating, based on the at least one image, first image information that corresponds to the building feature within the space;
determining, by the computing device, an origin point within the space to associate with a data file for recalling the building feature within a display of the computing device based at least in part on the relative location of the computing device, the first image information, the building feature within the space, and received second image information that corresponds to objects within the space; and
generating, by the computing device, the data file that includes a data object for the building feature, the distance to the building feature within the space, the relative location of the computing device with respect to the building feature, the first image information, and the second image information, the data file configured to present, within a display of the computing device, a 3D representation of the building feature in a particular location of the display that visually corresponds to the location of the building feature within the space, the 3D representation being recallable by the computing device based at least in part on the origin point and configured to present the 3D representation within the display after an obscuring object is installed within the space so as to physically obscure the building feature from view by the computing device.

2. The computer-implemented method of claim 1, wherein the computing device captures the depth information using one or more depth sensors.

3. The computer-implemented method of claim 2, wherein the one or more depth sensors include one or more stereoscopic cameras of the computing device.

4. The computer-implemented method of claim 1, further comprising calculating physical dimensions for the building feature in the space based at least in part on the depth information.

5. The computer-implemented method of claim 1, wherein the user input associates the building feature with a particular utility.

6. The computer-implemented method of claim 1, further comprising receiving information, via the user interface, that modifies metadata for the data file that corresponds to the data object for the building feature, the metadata comprising particular information that corresponds to a type of utility line or a type of structural component.

7. The computer-implemented method of claim 1, wherein the data file is configured to be presented in a web browser.

8. A system comprising:
one or more camera devices;
a processor;
a display; and
a memory including instructions that, when executed with the processor, cause the system to, at least:
obtain, from the one or more camera devices, depth information that corresponds to a plurality of points in a space captured by the one or more camera devices, the plurality of points in the space associated with input received by the system;
calculate, using the depth information, a distance from the one or more camera devices to the plurality of points in the space and physical dimensions for a building feature associated with the plurality of points in the space;
obtain, from the one or more camera devices, first image information for the building feature;
obtain, from the one or more camera devices, second image information for one or more objects within the space;
determine an origin point within the space to associate with a data file for recalling the building feature within the display based at least in part on the distance, the building feature associated with the plurality of points in the space, the first image information, and the second image information; and
generate the data file that includes a 3D representation of the building feature within the space and conforms to the calculated distance and the physical dimensions based at least in part on the first image information, the second image information, and the calculated distance, the data file configured to present, within the display, the 3D representation of the building feature in a particular location of the display that visually corresponds to the location of the building feature within the space, the 3D representation being recallable by the processor based at least in part on the origin point and configured to present the 3D representation within the display after an obscuring object is installed within the space so as to physically obscure the building feature from view by the system.

9. The system of claim 8, wherein the data file is further configured to be consumed by an application of a computer device to present the 3D representation of the building feature within the space.

10. The system of claim 9, wherein presenting the 3D representation of the building feature within the space comprises presenting, within the display, the 3D representation of the building feature in a location within the space and between a current location of the computer device and the location of the building feature.

11. The system of claim 10, wherein the application is configured to display an augmented reality image that corresponds to the first image information and the second image information.

12. The system of claim 10, wherein presenting the 3D representation of the building feature within the space, via the application, is in response to matching the augmented reality image to a particular portion of the space that corresponds to the second image information.

13. The system of claim 8, wherein the instructions are further configured to cause the system to at least:
in response to a request for the data file:
generate an image file that comprises a static image of the 3D representation of the building feature within the space that conforms to the calculated distance and the physical dimensions; and
transmit the image file to a requestor associated with the request.

14. An apparatus comprising:
a camera device configured to capture image information;
a depth sensor device configured to capture depth information;
a mobile application stored in a computer-readable medium that, when executed, causes the apparatus to, at least:
receive depth information from the depth sensor for one or more points within a space that correspond to first image information captured using the camera device, the one or more points indicated via the mobile application;
receive user input, via the mobile application, that indicates a type of building feature to associate with the one or more points within the space;
calculate, using the depth information and the user input, a distance and physical dimensions for the building feature within the space that corresponds to the one or more points;
receive second image information captured using the camera device that corresponds to one or more objects within the space;
determine an origin point within the space to associate with a data file for recalling the building feature within a display of the mobile application based at least in part on the distance, the building feature associated with the one or more points within the space, the first image information, and the second image information; and
generate the data file that includes a data object that comprises a 3D representation of the building feature within the space that is configured to communicate, via the display of the mobile application, a first location of the building feature within the space relative to the apparatus and the physical dimensions for the building feature based at least in part on the depth information, the first image information, and the second image information,
wherein, after an obscuring object is installed within the space so as to physically obscure the building feature from view by the apparatus, the 3D representation is recallable by the mobile application based at least in part on the origin point and configured to present the 3D representation within the display in a particular location of the display that visually corresponds to the location of the building feature.

15. The apparatus of claim 14, wherein the mobile application is further configured to cause the apparatus to capture, using the camera device, an image of an object of the one or more objects or a structural feature within the space to associate with the 3D representation of the object.

16. The apparatus of claim 14, wherein the mobile application is further configured to present, via the mobile application, an augmented reality presentation of the second image information within the space to match to a real-time image of the space to further present the data object within the space.

17. The apparatus of claim 14, wherein the mobile application is further configured to use the one or more points within the space to identify a plurality of types of objects within the space.

18. The apparatus of claim 17, wherein each type of object of the plurality of types of objects is stored as a layer within the data object.

19. The apparatus of claim 14, wherein the apparatus further comprises an accelerometer and a compass.

20. The apparatus of claim 19, wherein the mobile application is further configured to determine a relative location of the apparatus within the space based at least in part on sensor input obtained by the accelerometer and the compass in response to receiving the user input.
